(19) United States
(12) Patent Application Publication
(10) Pub. No.: US 2024/0144053 A1
(43) Pub. Date: May 2, 2024

(54) INFERENCE ANALYSIS APPARATUS, INFERENCE APPARATUS, INFERENCE ANALYSIS METHOD, AND COMPUTER-READABLE RECORDING MEDIUM

(71) Applicant: NEC Corporation, Minato-ku, Tokyo (JP)

(72) Inventors: Daichi KIMURA, Tokyo (JP); Itaru HOSOMI, Tokyo (JP)

(73) Assignee: NEC Corporation, Minato-ku, Tokyo (JP)

(21) Appl. No.: 18/280,847

(22) PCT Filed: Mar. 11, 2021
(86) PCT No.: PCT/JP2021/009883

§ 371 Date: Sep. 7, 2023

(51) Int. Cl. G06N 5/04

(52) U.S. Cl. CPC G06N 5/04

(57) ABSTRACT

An inference analysis apparatus includes: a hypothetical logical expression designation unit that receives, in a case where any of hypothetical logical expressions constituting a hypothesis generated by inference that applies inferential knowledge to observed logical expressions is designated, the designated hypothetical logical expression; a knowledge extraction unit that extracts inferential knowledge whose consequent includes the designated hypothetical logical expression, from the inferential knowledge; and an observed logical expression extraction unit that specifies a logical expressions included in an antecedent of the extracted inferential knowledge, and extracts a observed logical expressions whose predicate is the same as the specified logical expressions, from the observed logical expressions.

### TECHNICAL FIELD

The present invention relates to an inference analysis apparatus, an inference apparatus including the same and an inference analysis method that are for analyzing the results of abduction performed on events that are observed, and further relates to a computer-readable recording medium for realizing the apparatuses and method.

### BACKGROUND ART

For example, in the field of cybersecurity, when an event of some sort is observed in a computer system, it is necessary to determine whether or not the event that is observed is due to a cyberattack. Abduction is the most promising technique for making such determinations.

Abduction involves deriving a valid hypothesis from the event that has been observed (hereinafter referred to as “observed event”) and inferential knowledge (rules) provided by logical expressions. Accordingly, in the case of the above example, by applying the observed event to rules that are prepared in advance for the computer system and deriving a hypothesis, it can be easily determined whether or not there has been a cyberattack.

Also, in general abduction, simpler hypotheses are considered better, and thus if multiple hypotheses are envisaged, it is necessary to specify the best hypothesis. In other words, in general abduction, there is a constraint that at most one backward chaining operation is applicable to a single logical expression.

One technique for specifying the best hypothesis is weighted abduction (e.g., see Non-Patent Document 1). In weighted abduction, a weight is assigned to each rule, and a cost is further assigned to each observed event. Backward chaining is then performed on the weighted rules and costed observed events to generate hypothesis candidates, and the cost of each hypothesis candidate is additionally calculated by a unification operation. Also, hypothesis candidates having a smaller cost, among the generated hypothesis candidates, are considered better, and the hypothesis with the smallest cost is called a solution hypothesis.

Here, weighted abduction will be specifically described using FIG. 9. FIG. 9 is a diagram illustrating an example of conventional weighted abduction. Assume that the observed event and the rules are as illustrated in FIG. 9. The solution hypothesis that is obtained from the observed event and the rules in this case will be examined. In the observed event and the rules illustrated in FIG. 9, X is a predicate indicating an attack means. A to G are predicates indicating evidence. In FIG. 9, the black boxes indicate observed literals and the white boxes indicate hypothetical literals. Also, the arrows indicate backward chaining in the direction of the arrows, and the dashed lines indicate unification.

Furthermore, the literals with A to G as predicates are observable events, that is, literals that can become “observed literals”. The values “t1”, “T21” and the like of the terms indicate times. “query” is a predicate indicating a query for performing abduction. Note that, hereinafter, literals may be described by only the predicate with the term omitted, such as “X” or “A”. Also, the numerical values in the rules indicate weights, and the numerical value in each observed literal indicates cost.

By applying the observed event illustrated in FIG. 9 to the rules likewise illustrated in FIG. 9, a solution hypothesis illustrated in FIG. 9 is obtained. In this solution hypothesis, hypothetical literals A and B are derived by backward chaining operations as evidence of the attack means X, and are unified with observed literals A(T11) and B(T11), respectively. That is, X is associated with the observed literals A(T11) and B(T11).

### LIST OF RELATED ART DOCUMENTS

### Non-Patent Document

Non-Patent Document 1: J. R. Hobbs, M. Stickel, P. Martin, and D. Edwards, “Interpretation as abduction,” Artificial Intelligence, Vol. 63, pp. 69-142, 1993.

### SUMMARY OF INVENTION

### Problems to be Solved by the Invention

Incidentally, in the example of FIG. 9, there is also a rule “C(t2):0.5\hat{ }D(t2):0.5=>X(t2)”, and thus it is also possible that X is associated with the observed literals C(T21) and D(T21). However, because the solution hypothesis illustrated in FIG. 9 has been obtained under the above-described constraint, hypothesis 1 illustrated in FIG. 10 cannot be obtained. FIG. 10 illustrates another example of a hypothesis that could possibly be obtained from the rules and the observed event illustrated in FIG. 9. Similarly in FIG. 10, the black boxes indicate observed literals, and the white boxes indicate hypothetical literals. Also, the arrows indicate backward chaining in the direction of the arrows, and the dashed lines indicate unification.

In other words, there is a problem with the conventional abduction disclosed in Non-Patent Document 1 in that, even if there are multiple rules that derive the same consequent and multiple observed literals corresponding to antecedents of the rules, only one solution hypothesis, that is, only one rule, is illustrated.

In the above example, E and F could also possibly be extracted as hypothetical literals from the rule “E(t3):0.5\hat{ }F(t3):0.5=>X(t3)”, but, as described above, when the solution hypothesis illustrated in FIG. 9 has been obtained, hypothesis 2 has a higher cost than the solution hypothesis, and thus the possibility of E and F being extracted as hypothesis 2 is zero. In particular, F is not included in the observed event, and thus there is no indication that F even exists.

In other words, although some of the literals have not been observed, hypotheses could possibly be supported by the rules that include these literals. However, there is also a problem with the conventional abduction disclosed in Non-Patent Document 1 in that, even if there is such a possibility, hypothetical literals that have not been observed but are included in the rules will not be illustrated due to another hypothesis being supported.

When abduction is applied to cybersecurity, these problems could possibly make it difficult for an administrator of a computer system to respond quickly and reliably to cyberattacks because the administrator is not able to grasp all possible hypotheses.

An example object of the invention is to provide an inference analysis apparatus, an inference apparatus, an inference analysis method and a computer-readable recording medium that can comprehensively present hypotheses that are derived from abduction performed on observed events.

### Means for Solving the Problems

In order to achieve the above-described object, an inference analysis apparatus includes:
a hypothetical logical expression designation unit that receives, in a case where any of hypothetical logical expressions constituting a hypothesis generated by inference that applies inferential knowledge to observed logical expressions is designated, the designated hypothetical logical expression;
a knowledge extraction unit that extracts inferential knowledge whose consequent includes the designated hypothetical logical expression, from the inferential knowledge; and
an observed logical expression extraction unit that specifies one or more logical expressions included in an antecedent of the extracted inferential knowledge, and extracts one or more observed logical expressions whose predicate is the same as the one or more specified logical expressions, from the observed logical expressions.

In order to achieve the above-described object, an inference apparatus includes:
a hypothesis generation unit that generates a hypothesis by executing inference that applies inferential knowledge to observed logical expressions;
a hypothetical logical expression designation unit that receives, in a case where any of hypothetical logical expressions constituting the generated hypothesis is designated, the designated hypothetical logical expression;
a knowledge extraction unit that extracts inferential knowledge whose consequent includes the designated hypothetical logical expression, from the inferential knowledge; and
an observed logical expression extraction unit that specifies one or more logical expressions included in an antecedent of the extracted inferential knowledge, and extracts one or more observed logical expressions whose predicate is the same as the one or more specified logical expressions, from the observed logical expressions.

In order to achieve the above-described object, an inference analysis includes:
a hypothetical logical expression designation step of receiving, in a case where any of hypothetical logical expressions constituting a hypothesis generated by inference that applies inferential knowledge to observed logical expressions is designated, the designated hypothetical logical expression;
a knowledge extraction step of extracting inferential knowledge whose consequent includes the designated hypothetical logical expression, from the inferential knowledge; and
an observed logical expression extraction step of specifying one or more logical expressions included in an antecedent of the extracted inferential knowledge, and extracting one or more observed logical expressions whose predicate is the same as the one or more specified logical expressions, from the observed logical expressions.

In order to achieve the above-described object, a computer readable recording medium according to an example aspect of the invention is a computer readable recording medium that includes recorded thereon a program,
the program including instructions that cause the computer to carry out:
a hypothetical logical expression designation step of receiving, in a case where any of hypothetical logical expressions constituting a hypothesis generated by inference that applies inferential knowledge to observed logical expressions is designated, the designated hypothetical logical expression;
a knowledge extraction step of extracting inferential knowledge whose consequent includes the designated hypothetical logical expression, from the inferential knowledge; and
an observed logical expression extraction step of specifying one or more logical expressions included in an antecedent of the extracted inferential knowledge, and extracting one or more observed logical expressions whose predicate is the same as the one or more specified logical expressions, from the observed logical expressions.

### Advantageous Effects of the Invention

As described above, according to the invention, it is possible to comprehensively present hypotheses that are derived from abduction performed on observed events.

### BRIEF DESCRIPTION OF THE DRAWINGS

FIG. 1 is a configuration diagram illustrating a schematic configuration of the inference analysis apparatus of the example embodiment.

FIG. 2 is a configuration diagram specifically illustrating the configurations of the inference analysis apparatus and the inference apparatus of the example embodiment.

FIG. 3 is a diagram illustrating an example of observed literals presented by the presentation unit in the example embodiment.

FIG. 4 is a flow diagram illustrating operations of the inference analysis apparatus and the inference apparatus of the example embodiment.

FIG. 5 illustrates observed literals that are presented in specific example 1.

FIG. 6 illustrates observed literals that are presented in specific example 2.

FIG. 7 illustrates an observed event and rules that are used in specific example 4 and a solution hypothesis generated therefrom.

FIG. 8 is a block diagram illustrating an example of a computer that realizes the inference analysis apparatus and the inference apparatus according to the example embodiment.

FIG. 9 is a diagram illustrating an example of conventional weighted abduction.

FIG. 10 illustrates another example of a hypothesis that could possibly be obtained from the rules and the observed event illustrated in FIG. 9.

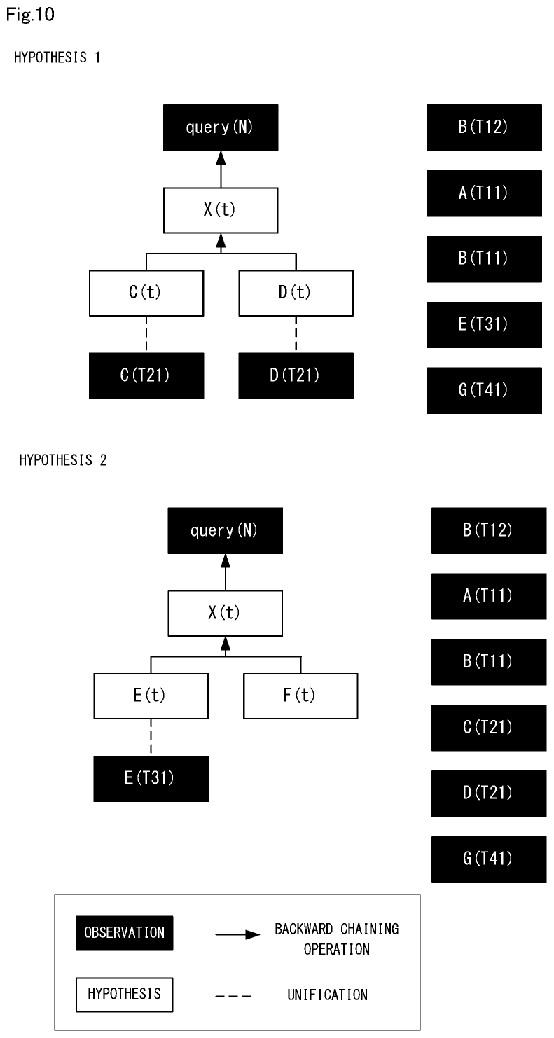

### EXAMPLE EMBODIMENTS

### Example Embodiment

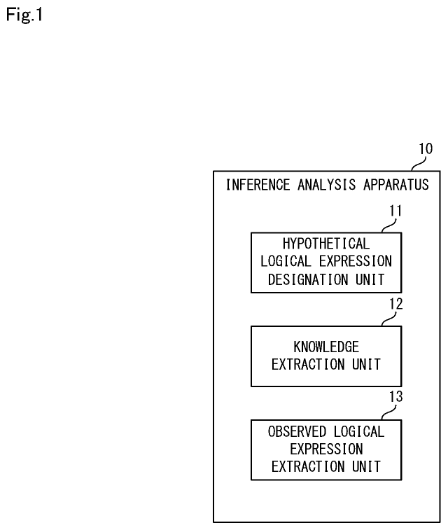

Hereinafter, in an example embodiment, an inference analysis apparatus, an inference apparatus, an inference analysis method and a program will be described with reference to FIGS. 1 to 8.

[Apparatus Configuration]

Initially, a schematic configuration of the inference analysis apparatus of the example embodiment will be described using FIG. 1. FIG. 1 is a configuration diagram illustrating a schematic configuration of the inference analysis apparatus of the example embodiment.

An inference analysis apparatus 10 illustrated in FIG. 1 is an apparatus for analyzing the results of abduction performed on observed events. As illustrated in FIG. 1, the inference analysis apparatus 10 includes a hypothetical logical expression designation unit 11, a knowledge extraction unit 12, and an observed logical expression extraction unit 13.

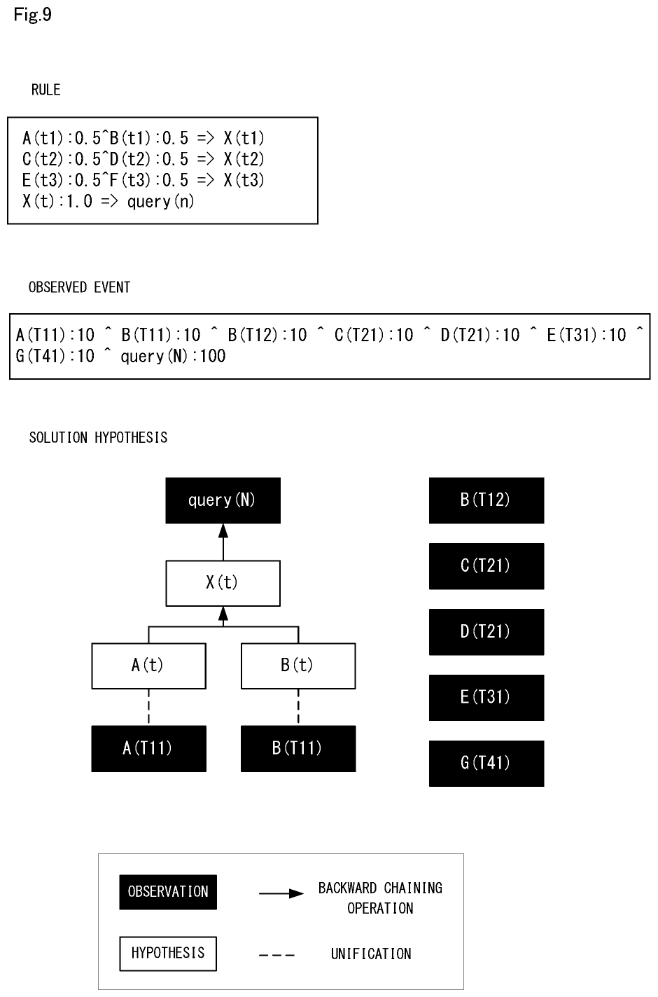

First, in the example embodiment, a hypothesis is generated by inference that applies inferential knowledge (hereinafter referred to as “rules”) to observed logical expressions constituting an observed event. Here, the observed logical expressions constituting the observed event are a conjunction of literals that have been observed such as illustrated in FIG. 9 and the like. Note that, hereinafter, both the case of a conjunction indicating an entire observed event and the case of indicating individual literals will be referred to as “observed literals”.

The hypothetical logical expression designation unit 11, in the case where any of the hypothetical logical expressions constituting this hypothesis is designated, receives the designated hypothetical logical expression. In the example embodiment, the literals of a single hypothesis (hereinafter referred to as “hypothetical literals”) are treated as hypothetical logical expressions, but the case where multiple hypothetical literals are designated or where a conjunction of multiple hypothetical literals is designated can also obviously be easily accommodated.

The knowledge extraction unit 12 extracts rules whose consequent includes the designated hypothetical literal, from the rules. The observed logical expression extraction unit 13 specifies logical expressions that are included in the antecedents of the extracted rules (in the example embodiment, each literal constituting the antecedents), and extracts observed literals whose predicate is the same as the specified literals, from the observed literals.

In this way, the inference analysis apparatus 10 extracts rules whose consequent includes the designated hypothetical literal, and further specifies literals that are included in the antecedents of the extracted rules, from the observed literals. With these specified literals, possible hypotheses can then be specified, in addition to the solution hypothesis that is obtained by abduction. As a result, with the inference analysis apparatus 10, it is possible to comprehensively present hypotheses that are derived from abduction performed on observed events.

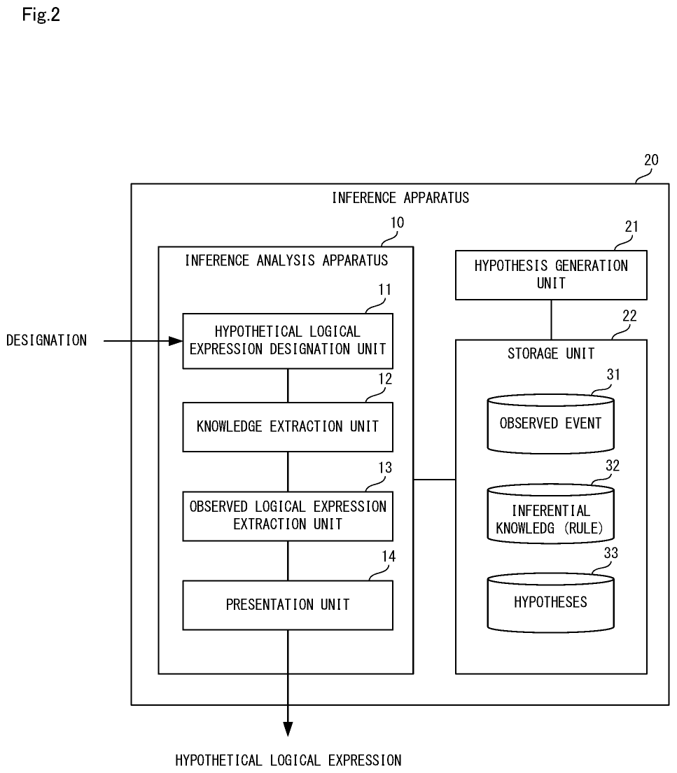

Next, the configuration and function of the inference analysis apparatus in the example embodiment will be specifically described, using FIG. 2. FIG. 2 is a configuration diagram specifically illustrating the configurations of the inference analysis apparatus and the inference apparatus of the example embodiment.

As illustrated in FIG. 2, in the example embodiment, the inference analysis apparatus 10 constitutes part of an inference apparatus 20. The inference apparatus 20 includes a hypothesis generation unit 21 and a storage unit 22, in addition to the inference analysis apparatus 10.

In the inference apparatus 20, the storage unit 22 stores an observed event 31 and rules 32 that are used in generating hypotheses. The hypothesis generation unit 21 acquires the observed event 31 and the rules 32 from the storage unit 22. The hypothesis generation unit 21 then applies the rules 32 to observed literals constituting the observed event 31 and executes inference. Hypotheses 33 are thereby generated. Also, the hypothesis generation unit 21 stores the generated hypotheses 33 in the storage unit 22.

For example, assume that the storage unit 22 stores the observed event and the rules illustrated in FIG. 9 as the observed event 31 and the rules 32. In this case, the hypothesis generation unit 21 generates the hypothesis (solution hypothesis 1) illustrated in FIG. 9 as a hypothesis 33 and stores the generated hypothesis in the storage unit 22.

Also, in the example embodiment, in the inference analysis apparatus 10, when a hypothetical literal is designated by a user, the hypothetical logical expression designation unit 11 receives the designated hypothetical literal, and inputs the received hypothetical literal to the knowledge extraction unit 12. Also, in the example embodiment, designation of a hypothetical literal by the user is performed via a terminal device of the user or via an input device such as a keyboard.

The knowledge extraction unit 12, in the example embodiment, accesses the storage unit 22 and extracts rules whose consequent includes the hypothetical literal input from the hypothetical logical expression designation unit 11, from the rules 32 that are stored. Also, the knowledge extraction unit 12 inputs the extracted rules to the observed logical expression extraction unit 13.

The observed logical expression extraction unit 13, in the example embodiment, first specifies literals that are included in the antecedents of the input rules. The observed logical expression extraction unit 13 then accesses the storage unit 22 and extracts observed literals whose predicates are the same as the specified literals, from the observed logical expressions constituting the observed event 31.

As illustrated in FIG. 2, in the example embodiment, the inference analysis apparatus 10 includes a presentation unit 14, in addition to the hypothetical logical expression designation unit 11, the knowledge extraction unit 12 and the observed logical expression extraction unit 13 described above. The presentation unit 14 presents the observed literals extracted by the observed logical expression extraction unit 13. Also, in the example embodiment, presentation is performed by outputting the observed literals to an external terminal device or by displaying the observed literals on a screen of an external display device. Note that, in the case of the former, the observed literals are displayed on a screen of the terminal device.

For example, assume that the hypothesis illustrated in FIG. 9 (solution hypothesis 1) is generated as a hypothesis 33, as described above. Also, assume that the user designates “X” as a hypothetical literal. In this case, the knowledge extraction unit 12 extracts the following rules.
A(t1):0.5\hat{ }(t1):0.5=>X(t1)
C(t2):0.5\hat{ }D(t2):0.5=>X(t2)
E(t3):0.5\hat{ }F(t3):0.5=>X(t3)

Next, the observed logical expression extraction unit 13 specifies “A”, “B”, “C”, “D”, “E” and “F” as literals that are included in the antecedents of the three rules extracted by the knowledge extraction unit 12. The observed logical expression extraction unit 13 then extracts “A(T11)”, “B(T11)”, “B(T12)”, “C(T21)”, “D(T21)” and “E(T31)” as observed literals whose predicates are the same as the specified literals, from the observed logical expressions constituting the observed event 31.

The observed logical expression extractor 13 is also able to select a literal that satisfies a set condition from the specified literals, and extract an observed literal whose predicate is the same with respect to only the selected literal. The set condition includes not being excluded in advance, for example.

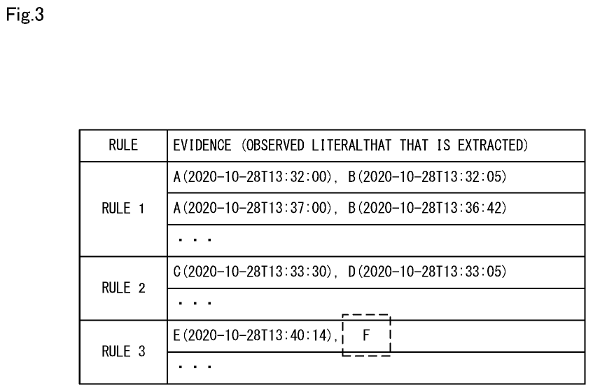

Thereafter, the presentation unit 14 presents the extracted “A(T11)”, “B(T11)”, “B(T12)”, “C(T21)”, “D(T21)” and “E(T31)”. The function of the presentation unit 14 will be described in detail using FIG. 3. FIG. 3 is a diagram illustrating an example of observed literals presented by the presentation unit in the example embodiment.

As illustrated in FIG. 3, the presentation unit 14 classifies the observed literals that are extracted, for the rules, and presents these observed literals as evidence in a classified state. The rules at this time are rules that include the literals specified at the time of extracting the observed literals.

Also, the presentation unit 14 presents literals not extracted as the observed literals, among the literals specified by the observed logical expression extraction unit 13, in a manner distinguishable from the observed literals that are extracted. In the example of FIG. 3, “F” is presented enclosed by a dashed line so as to be distinguishable from the other literals.

Additionally, assume that a plurality of literals have been specified and that a plurality of observed literals have been extracted by the observed logical expression extraction unit 13. In this case, the presentation unit 14 can also determine, in accordance with set rules, whether there is a relation between any of the observed literals that are extracted, and collectively present observed literals determined to have a relation with each other. Examples of the set rules include the values of the terms included in the literals being the same, and the time difference being within a set range.

[Apparatus Operations]

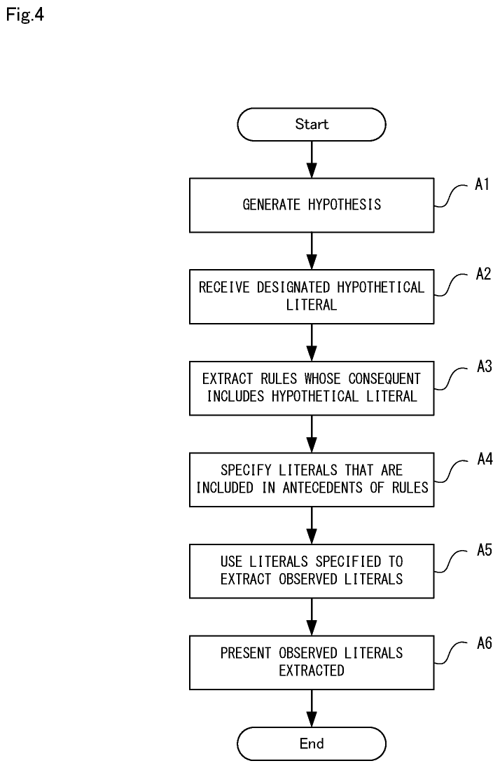

Next, the operations of the inference analysis apparatus 10 and the inference apparatus 20 in the example embodiment will be described using FIG. 4. FIG. 4 is a flow diagram illustrating operations of the inference analysis apparatus and the inference apparatus of the example embodiment. In the following description, FIGS. 1 to 3 will be referred to as appropriate. Also, in the example embodiment, an inference analysis method is implemented by operating the inference analysis apparatus 10, and an inference method is implemented by operating the inference apparatus 20. Therefore, the following description of the operations of the inference analysis apparatus 10 and the inference apparatus 20 will be given in place of a description of the inference analysis method and the inference method of the example embodiment.

Initially, as illustrated in FIG. 4, in the inference apparatus 20, the hypothesis generation unit 21 executes inference by applying rules 32 to observed literals constituting an observed event 31, and generates a hypothesis 33 (step A1). Also, the hypothesis generation unit 21 stores the hypothesis 33 generated in step A1 in the storage unit 22.

Next, in the inference analysis apparatus 10, when the user designates a hypothetical literal via a terminal device or the like, the hypothetical logical expression designation unit 11 receives the designated hypothetical literal (step A2). The hypothetical logical expression designation unit 11 then inputs the received hypothetical literal to the knowledge extraction unit 12.

Next, the knowledge extraction unit 12 extracts rules whose consequent includes the hypothetical literal received in step A2 from the rules 32 that are stored in the storage unit 22 (step A3). Also, the knowledge extraction unit 12 inputs the extracted rules to the observed logical expression extraction unit 13.

Next, the observed logical expression extraction unit 13 specifies literals that are included in the antecedents of the rules extracted in step A3 (step A4).

Next, the observed logical expression extraction unit 13 uses the literals specified in step A4 to extract observed literals whose predicate is the same as the specified literals, from the observed logical expressions constituting the observed event 31 that is stored in the storage unit 22 (step A5).

Next, the presentation unit 14 presents the observed literals extracted in step A5 on the screen of a display device or a terminal device (step A6). Specifically, as illustrated in FIG. 3, the presentation unit 14 classifies the observed literals that are extracted, for the rules, and presents these observed literals in a classified state. Also, the presentation unit 14 presents literals that are not extracted as the observed literals, among the literals specified by the observed logical expression extraction unit 13, in a manner distinguishable from the observed literals that are extracted.

### Effects of Example Embodiment

As described above, in the example embodiment, not only the solution hypothesis but also hypotheses that are derived by abduction performed on observed events are comprehensively presented. Also, in the example embodiment, the observed literals that are extracted are collectively presented for each rule that is used in extracting the observed literals, as evidence, and thus the logic that is applied when a hypothesis is supported by a combination of evidence can be easily grasped. Furthermore, in the example embodiment, literals that have not actually been observed are presented, and thus observed events that could possibly exist despite not having been observed can also be easily grasped. Additionally, in the example embodiment, related evidence can be collectively presented, thus making it easier to grasp the relation between evidence.

### SPECIFIC EXAMPLES

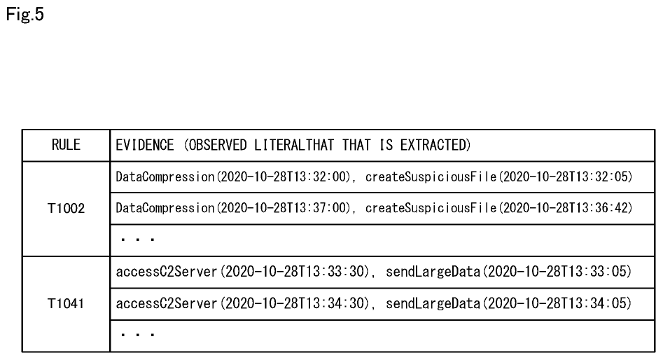

Next, specific examples of the processing by the inference analysis apparatus 10 of the example embodiment will be described, using FIGS. 5 to 7. In the following specific examples, rules are constructed using MITRE'S ATT&CK Matrix for Enterprise (Reference: https://attack.mitre.org/). ATT&CK Matrix for Enterprise has a hierarchical structure with various tactics of cyberattacks as an upper layer and techniques for realizing the respective tactics as a lower layer.

### Specific Example 1

Specific Example 1 will be described using FIG. 5. FIG. 5 illustrates observed literals that are presented in specific example 1.

In specific example 1, assume that rules whose consequent is “Exfiltration”, such as the following, are constructed with ATT&CK Matrix for Enterprise. The rules each signify that, when literals in the antecedent of the rule are observed, the tactic “Exfiltration” is realized by the technique illustrated by the rule name.
DataCompression(t1)\hat{ }createSuspiciousFile(t2)=>Exfiltration(t1)
Rule name: T1002_DataCompressed
accessC2Server(t3)\hat{ }sendLargeData(t4)=>Exfiltration(t3)
Rule name: T1041ExfiltrationOverCommandandControlChannel

The literals in the antecedents of the rules signify the following.
DataCompression: Data compression was executed
createSuspiciousFile: Suspicious file was created
accessC2Server: Access to C2 (Command and Control) server
sendLargeData: Large amount of data was transmitted

Assume that “Exfiltration” is then designated as a hypothetical literal. In this case, the observed literals that are presented will be as illustrated in FIG. 5.

As illustrated in FIG. 5, in specific example 1, techniques that could possibly have been used in order to realize “Exfiltration” in cyberattacks are listed. As a result, the system administrator is able to gain an overview of the characteristics of cyberattacks on the system, and is, for example, able to be aware of methods typically used by specific groups of attackers.

Also, the system administrator is able to specify a list of rules with which a hypothesis can be supported from the Rules column illustrated in FIG. 5. Furthermore, the system administrator is also able to grasp, from the Rules and Evidence columns, the logic with which a hypothesis is supported by a combination of evidence.

Additionally, the system administrator is able to compare the rules, based on the presentation contents illustrated in FIG. 5, and is also able to prioritize countermeasures against cyberattacks from the comparison results. In other words, when there is a large amount of evidence, the system administrator is able to judge which evidence should be given highest priority in response to a cyberattack. For example, in FIG. 5, in the case where rule T1041 (communication of large amount of data with C2 server) should be prioritized over rule T1002 (creation of suspicious compressed file), the system administrator first responds based on the evidence related to rule T1041.

### Specific Example 2

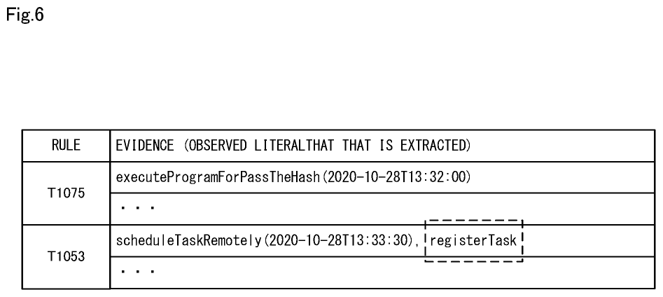

Specific example 2 will be described using FIG. 6. FIG. 6 illustrates observed literals that are presented in specific example 2.

In specific example 2, assume that rules such as the following are constructed with ATT&CK Matrix for Enterprise. Similarly to specific example 1, the rules each signify that, when literals in the antecedent of the rule are observed, the tactic “LateralMovement” is realized by the technique illustrated by the rule name.
executeProgramForPassTheHash(t1)=>LateralMovement(t1)
Rule name: T1075_PasstheHash
scheduleTaskRemotely(t3)\hat{ }registerTask(t4)=>LateralMovement(t3)
Rule name: T1053_ScheduledTask

The literals in the antecedent of the rules signify the following.
executeProgramForPassTheHash: Program for realizing Pass The Hash was executed
scheduleTaskRemotely: Scheduled task was set in remote device
registerTask: Registered task

Also, in specific example 2, assume that “executeProgramForPassTheHash” and “scheduleTaskRemotely” are included in the observed event. Assume that “LateralMovement” is then specified as a hypothetical literal. In this case, the observed literals that are presented are as illustrated in FIG. 6.

As illustrated in FIG. 6, in specific example 2, “registerTask” does not exist in the observed event, but by referring to the antecedent of rule T1053, “registerTask” is presented enclosed by a dashed line, so as to be distinguishable from the observed literals extracted from the observed event. Evidence that has not been observed at the current point in time but could possibly be revealed by more detailed investigation is thus suggested to the system administrator as a hypothesis.

In other words, in specific example 2, the setting of a scheduled task in a remote device has been observed, but it is not known whether there is a “registered task” in the remote device. In this case, the system administrator is able to judge whether or not the existence of a registered task needs to be investigated.

In the conventional abduction described in the Background Art, the cost a hypothesis with hypothetical literals that do not bring about unification is generally higher, and thus a solution hypothesis in which “executeProgramForPassTheHash” is associated as evidence of “LateralMovement” (rule T1075 is employed) is obtained. Since a hypothetical literal “registerTask” based on rule T1053 is not presented at all, the system administrator will thus be unaware of the possibility of “registerTask”.

Rules in which all the literals that are included in the antecedent are not observed need not be presented. In other words, in specific example 2 described above, assume that only “executeProgramForPassTheHash” is included in the observed event. In this case, with regard to rule T1053, there is no lead to investigate because all the literals in the antecedent have not been observed. Thus, such rules need not be presented.

### Specific Example 3

The presentation unit 14 is also able to determine whether there is a relation between any of the observed literals that are extracted, in accordance with set rules, and collectively present observed literals determined to have a relation with each other.

For example, assume that the following rule exists, and that “trail1” and “trail2” are included in the observed event.
trail1(time1,p c,filename)\hat{ }trail2(time2,pc,user)=>Tactic1(time1)

In this case, in the above rule, the value “pc” of the terms is designated so as to be the same value for trail1 and trail2. Accordingly, in the case where the observed literals are “trail1(*,PC1,*)” and “trail2(*,PC1,*)”, it is possible to collectively present the observed literals. However, in the case where the observed literals are “trail1(*,PC1,*)” and “trail2(*,PC2,*)”, it is not possible to collectively present the observed literals. Here, “*” represents any given value. Note that the values “time1” and “time2” of the terms are times. Therefore, in the case where the difference between “time1” and “time2” is within a set range, “trail1” and “trail2” can be collectively presented.

In this way, according to specific example 3, it is possible for the system administrator to find a relation between “filename” and “user” that are not directly associated by the above-described rules.

### Specific Example 4

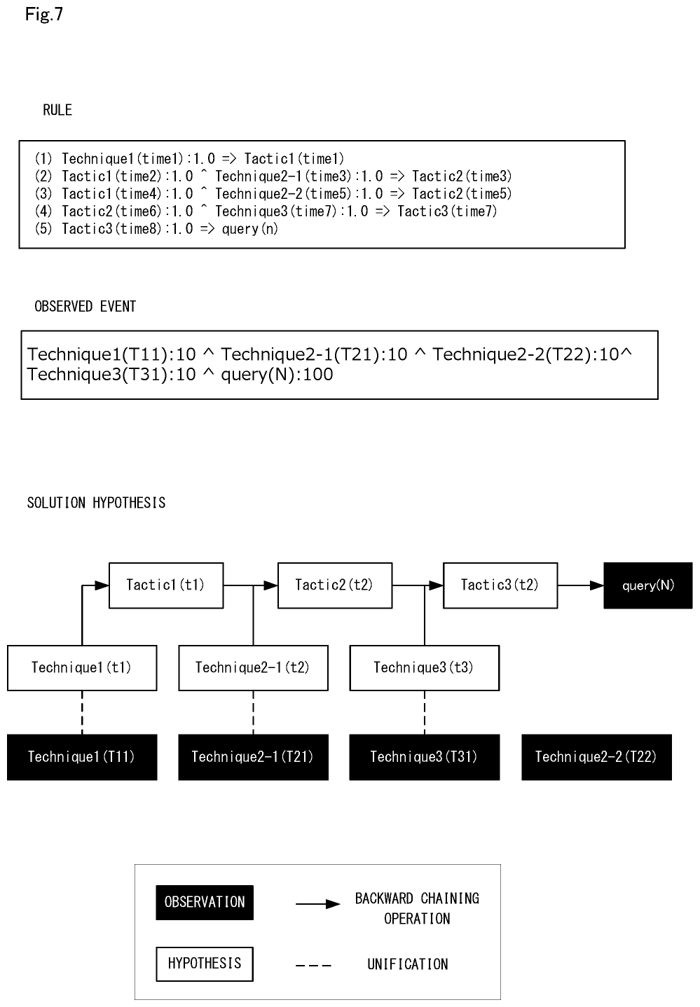

Specific example 4 will be described using FIG. 7. FIG. 7 illustrates an observed event and rules that are used in specific example 4 and a solution hypothesis generated therefrom. Similarly in FIG. 7, the black boxes indicate observed literals, and the white boxes indicates hypothetical literals. Also, the arrows indicate backward chaining in the direction of the arrows, and the dashed lines indicate unification.

In the example illustrated in FIG. 7, when “Tactic2(t2)” is designated as a hypothetical literal, for example, the knowledge extraction unit 12 extracts rules (2) and (3). Also, the observed logical expression extraction unit 13 specifies “Tactic1”, “Technique2-1” and “Technique2-2” as literals that are included in the antecedents of the rules.

Incidentally, in the example of FIG. 7, “Tactic1” is not observed in principle, and thus there is no point specifying it as a literal. It is thus better that not all literals that are included in the antecedents of the rules are targeted for extraction, and that the literals to be excluded from extraction are set in advance for each rule. In the example of FIG. 7, it is better that “Tactic1” is excluded from extraction in advance. Also, in the example of FIG. 7, the rules are designed such that tactics (“Tactic”) are chained as a solution hypothesis. Thus, only the Technique portion need be extracted as “evidence” of each “Tactic”.

[Program]

It suffices for a first program according to the example embodiment to be a program that causes a computer to carry out steps A2 to A6 illustrated in FIG. 4. By installing this program on a computer and executing the first program, the inference analysis apparatus 10 and the inference analysis method according to the example embodiment can be realized. In this case, one or more processors of the computer function and perform processing as the hypothetical logical expression designation unit 11, the knowledge extraction unit 12, the observed logical expression extraction unit 13 and the presentation unit 14. Furthermore, besides a general-purpose PC, a smartphone and a tablet-type terminal device can be mentioned as examples of the computer.

The first program according to the example embodiment may be executed by a computer system constructed from a plurality of computers. In this case, the computers may each function as one of the hypothetical logical expression designation unit 11, the knowledge extraction unit 12, the observed logical expression extraction unit 13 and the presentation unit 14, for example.

It suffices for a second program according to the example embodiment to be a program that causes a computer to carry out steps A1 to A6 illustrated in FIG. 4. By installing this program on a computer and executing the first program, the inference apparatus 20 and the inference method according to the example embodiment can be realized. In this case, one or more processors of the computer function and perform processing as the hypothesis generation unit 21, the hypothetical logical expression designation unit 11, the knowledge extraction unit 12, the observed logical expression extraction unit 13 and the presentation unit 14. In this case as well, besides a general-purpose PC, a smartphone and a tablet-type terminal device can be mentioned as examples of the computer.

Furthermore, in the example embodiment, the storage unit 22 may be realized by storing data files constituting the storage unit 22 in a storage device such as a hard disk provided in the computer, or may be realized by a storage device provided in another computer.

The second program according to the example embodiment may be executed by a computer system constructed from a plurality of computers. In this case, the computers may each function as one of the hypothesis generation unit 21, the hypothetical logical expression designation unit 11, the knowledge extraction unit 12, the observed logical expression extraction unit 13 and the presentation unit 14, for example.

[Physical Configuration]

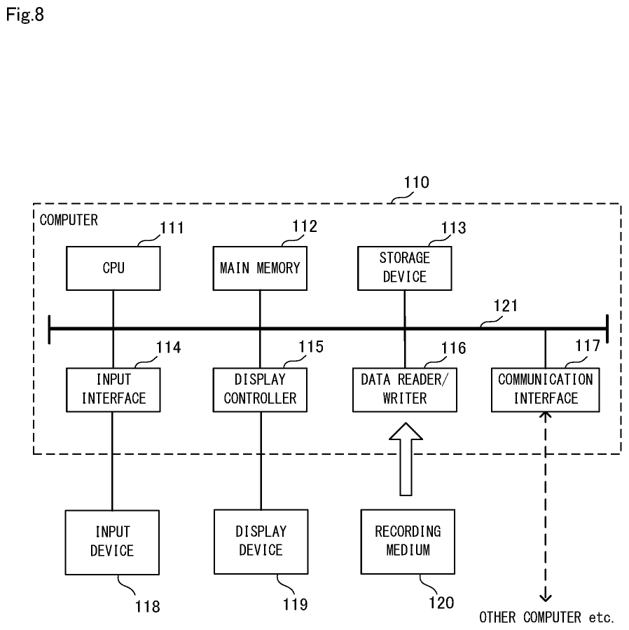

Using FIG. 8, the following describes a computer that realizes the inference analysis apparatus 10 and the inference apparatus 20 by executing the program according to the example embodiment. FIG. 8 is a block diagram illustrating an example of a computer that realizes the inference analysis apparatus and the inference apparatus according to the example embodiment.

As illustrated in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the inference analysis apparatus 10 and the inference apparatus 20 can also be realized by using items of hardware that respectively correspond to the components rather than the computer in which the program is installed. Furthermore, a part of the inference analysis apparatus 10 may be realized by the program, and the remaining part of the inference analysis apparatus 10 may be realized by hardware. And a part of the inference apparatus 20 may be realized by the program, and the remaining part of the inference apparatus 20 may be realized by hardware.

A part or an entirety of the above-described example embodiment can be represented by (Supplementary Note 1) to (Supplementary Note 21) described below but is not limited to the description below.
(Supplementary Note 1)

An inference analysis apparatus includes:
a hypothetical logical expression designation unit that receives, in a case where any of hypothetical logical expressions constituting a hypothesis generated by inference that applies inferential knowledge to observed logical expressions is designated, the designated hypothetical logical expression;
a knowledge extraction unit that extracts inferential knowledge whose consequent includes the designated hypothetical logical expression, from the inferential knowledge; and
an observed logical expression extraction unit that specifies one or more logical expressions included in an antecedent of the extracted inferential knowledge, and extracts one or more observed logical expressions whose predicate is the same as the one or more specified logical expressions, from the observed logical expressions.
(Supplementary Note 2)

The inference analysis apparatus according to Supplementary Note 1, further includes:
a presentation unit for presenting the one or more observed logical expressions extracted by the observed logical expression extraction unit.
(Supplementary Note 3)

The inference analysis apparatus according to Supplementary Note 2,
wherein the presentation unit classifies the one or more observed logical expressions that are extracted, for the inferential knowledge including the one or more specified logical expressions specified at the time of extracting the one or more observed logical expressions, and presents, in a classified state, the one or more observed logical expressions that are extracted.
(Supplementary Note 4)

The inference analysis apparatus according to Supplementary Note 2 or 3,
wherein the presentation unit presents a logical expression not extracted as the one or more observed logical expressions, among the one or more logical expressions specified by the observed logical expression extraction unit, in a manner distinguishable from the one or more observed logical expressions that are extracted.
(Supplementary Note 5)

The inference analysis apparatus according to any one of Supplementary Notes 2 to 4,
wherein the presentation unit, in a case where a plurality of logical expressions are specified and a plurality of observed logical expressions are extracted by the observed logical expression extraction unit, determines whether there is a relation between any of the observed logical expressions that are extracted, and collectively presents extracted observed logical expressions determined to have a relation with each other.
(Supplementary Note 6)

The inference analysis apparatus according to any one of Supplementary Notes 1 to 5,
wherein the observed logical expression extraction unit extracts an observed logical expression whose predicate is the same with respect to only a logical expression that satisfies a set condition, among the one or more specified logical expressions.
(Supplementary Note 7)

An inference apparatus includes:
a hypothesis generation unit that generates a hypothesis by executing inference that applies inferential knowledge to observed logical expressions;
a hypothetical logical expression designation unit that receives, in a case where any of hypothetical logical expressions constituting the generated hypothesis is designated, the designated hypothetical logical expression;
a knowledge extraction unit that extracts inferential knowledge whose consequent includes the designated hypothetical logical expression, from the inferential knowledge; and
an observed logical expression extraction unit that specifies one or more logical expressions included in an antecedent of the extracted inferential knowledge, and extracts one or more observed logical expressions whose predicate is the same as the one or more specified logical expressions, from the observed logical expressions.
(Supplementary Note 8)

An inference analysis method includes:
a hypothetical logical expression designation step of receiving, in a case where any of hypothetical logical expressions constituting a hypothesis generated by inference that applies inferential knowledge to observed logical expressions is designated, the designated hypothetical logical expression;
a knowledge extraction step of extracting inferential knowledge whose consequent includes the designated hypothetical logical expression, from the inferential knowledge; and
an observed logical expression extraction step of specifying one or more logical expressions included in an antecedent of the extracted inferential knowledge, and extracting one or more observed logical expressions whose predicate is the same as the one or more specified logical expressions, from the observed logical expressions.
(Supplementary Note 9)

The inference analysis method according to Supplementary Note 8, includes:
a presenting step of presenting the one or more observed logical expressions that are extracted in the observed logical expression extraction step.
(Supplementary Note 10)

The inference analysis method according to Supplementary Note 9, comprising:
in the presenting step, classifying the one or more observed logical expressions that are extracted, for the inferential knowledge including the one or more specified logical expressions specified at the time of extracting the one or more observed logical expressions, and presenting, in a classified state, the one or more observed logical expressions that are extracted.
(Supplementary Note 11)

The inference analysis method according to Supplementary Note 9 or 10, comprising:
in the presenting step, presenting a logical expression not extracted as the one or more observed logical expressions, among the one or more specified logical expressions, in a manner distinguishable from the one or more observed logical expressions that are extracted.
(Supplementary Note 12)

The inference analysis method according to any one of Supplementary Notes 9 to 11, comprising:
in the presenting step, in a case where a plurality of logical expressions are specified and a plurality of observed logical expressions are extracted, determining whether there is a relation between any of the observed logical expressions that are extracted, and collectively presenting extracted observed logical expressions determined to have a relation with each other.
(Supplementary Note 13)

The inference analysis method according to any one of Supplementary Notes 8 to 12, comprising:
in the observed logical expression extraction step, extracting an observed logical expression whose predicate is the same with respect to only a logical expression that satisfies a set condition, among the one or more specified logical expressions.
(Supplementary Note 14)

A computer-readable recording medium that includes a program recorded thereon, the program including instructions that cause a computer to carry out:
a hypothetical logical expression designation step of receiving, in a case where any of hypothetical logical expressions constituting a hypothesis generated by inference that applies inferential knowledge to observed logical expressions is designated, the designated hypothetical logical expression;
a knowledge extraction step of extracting inferential knowledge whose consequent includes the designated hypothetical logical expression, from the inferential knowledge; and
an observed logical expression extraction step of specifying one or more logical expressions included in an antecedent of the extracted inferential knowledge, and extracting one or more observed logical expressions whose predicate is the same as the one or more specified logical expressions, from the observed logical expressions.
(Supplementary Note 15)

The computer-readable recording medium according to Supplementary Note 14, the program further including instructions that cause the computer to carry out:
a presenting step of presenting the one or more observed logical expressions that are extracted in the observed logical expression extraction step.
(Supplementary Note 16)

The computer-readable recording medium according to Supplementary Note 15,
wherein the program causes the computer to carry out:
in the presenting step, classifying the one or more observed logical expressions that are extracted, for the inferential knowledge including the one or more specified logical expressions specified at the time of extracting the one or more observed logical expressions, and presenting, in a classified state, the one or more observed logical expressions that are extracted.
(Supplementary Note 17)

The computer-readable recording medium according to Supplementary Note 15 or 16,
wherein the program causes the computer to carry out:
in the presenting step, presenting a logical expression not extracted as the one or more observed logical expressions, among the one or more specified logical expressions, in a manner distinguishable from the one or more observed logical expressions that are extracted.
(Supplementary Note 18)

The computer-readable recording medium according to any one of Supplementary Notes 15 to 17,
wherein the program causes the computer to carry out:
in the presenting step, in a case where a plurality of logical expressions are specified and a plurality of observed logical expressions are extracted, determining whether there is a relation between any of the observed logical expressions that are extracted, and collectively presenting extracted observed logical expressions determined to have a relation with each other.
(Supplementary Note 19)

The computer-readable recording medium according to any one of Supplementary Notes 14 to 18,
wherein the program causes the computer to carry out:
in the presenting step, extracting an observed logical expression whose predicate is the same with respect to only a logical expression that satisfies a set condition, among the one or more specified logical expressions.
(Supplementary Note 20)

An inference method includes:
a hypothesis generation step of generating a hypothesis by executing inference that applies inferential knowledge to observed logical expressions;
a hypothetical logical expression designation step of receiving, in a case where any of hypothetical logical expressions constituting the generated hypothesis is designated, the designated hypothetical logical expression;
a knowledge extraction step of extracting inferential knowledge whose consequent includes the designated hypothetical logical expression, from the inferential knowledge; and
an observed logical expression extracting step of specifying one or more logical expressions included in an antecedent of the extracted inferential knowledge, and extracting one or more observed logical expressions whose predicate is the same as the one or more specified logical expressions, from the observed logical expressions.
(Supplementary Note 21)

A computer-readable recording medium that includes a program recorded thereon, the program including instructions that cause a computer to carry out:
a hypothesis generation step of generating a hypothesis by executing inference that applies inferential knowledge to observed logical expressions;
a hypothetical logical expression designation step of receiving, in a case where any of hypothetical logical expressions constituting the generated hypothesis is designated, the designated hypothetical logical expression;
a knowledge extraction step of extracting inferential knowledge whose consequent includes the designated hypothetical logical expression, from the inferential knowledge; and
an observed logical expression extracting step of specifying one or more logical expressions included in an antecedent of the extracted inferential knowledge, and extracting one or more observed logical expressions whose predicate is the same as the one or more specified logical expressions, from the observed logical expressions.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the invention, it is possible to comprehensively present hypotheses that are derived from abduction performed on observed events. The present invention is useful in various fields where the abduction is performed.

### REFERENCE SIGNS LIST

10 Inference analysis apparatus
11 Hypothetical logical expression designation unit
12 Knowledge extraction unit
13 Observed logical expression extraction unit
14 Presentation unit
15 Inference apparatus
21 Hypothesis generation unit
22 Storage unit
31 Observed event
32 Rule
33 Hypotheses
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An inference analysis apparatus comprising:
at least one memory storing instructions; and
at least one processor configured to execute the instructions to:
receive, in a case where any of hypothetical logical expressions constituting a hypothesis generated by inference that applies inferential knowledge to observed logical expressions is designated, the designated hypothetical logical expression;
extract inferential knowledge whose consequent includes the designated hypothetical logical expression, from the inferential knowledge; and
specify one or more logical expressions included in an antecedent of the extracted inferential knowledge, and extract one or more observed logical expressions whose predicate is the same as the one or more specified logical expressions, from the observed logical expressions.

2. The inference analysis apparatus according to claim 1,
further at least one processor configured to execute the instructions to:
present the one or more observed logical expressions extracted by the observed logical expression extraction means.

3. The inference analysis apparatus according to claim 2,
further at least one processor configured to execute the instructions to:
classify the one or more observed logical expressions that are extracted, for the inferential knowledge including the one or more specified logical expressions specified at the time of extracting the one or more observed logical expressions, and present, in a classified state, the one or more observed logical expressions that are extracted.

4. The inference analysis apparatus according to claim 2,
further at least one processor configured to execute the instructions to:
present a logical expression not extracted as the one or more observed logical expressions, among the one or more logical expressions specified by the observed logical expression extraction means, in a manner distinguishable from the one or more observed logical expressions that are extracted.

5. The inference analysis apparatus according to claim 2,
further at least one processor configured to execute the instructions to:
in a case where a plurality of logical expressions are specified and a plurality of observed logical expressions are extracted, determine whether there is a relation between any of the observed logical expressions that are extracted, and collectively present extracted observed logical expressions determined to have a relation with each other.

6. The inference analysis apparatus according to claim 1,
further at least one processor configured to execute the instructions to:
extract an observed logical expression whose predicate is the same with respect to only a logical expression that satisfies a set condition, among the one or more specified logical expressions.

7. An inference apparatus comprising:
at least one memory storing instructions; and
at least one processor configured to execute the instructions to:
generate a hypothesis by executing inference that applies inferential knowledge to observed logical expressions;
receive, in a case where any of hypothetical logical expressions constituting the generated hypothesis is designated, the designated hypothetical logical expression;
extract inferential knowledge whose consequent includes the designated hypothetical logical expression, from the inferential knowledge; and
specify one or more logical expressions included in an antecedent of the extracted inferential knowledge, and extract one or more observed logical expressions whose predicate is the same as the one or more specified logical expressions, from the observed logical expressions.

8. An inference analysis method comprising:
in a case where any of hypothetical logical expressions constituting a hypothesis generated by inference that applies inferential knowledge to observed logical expressions is designated, receiving the designated hypothetical logical expression;
extracting inferential knowledge whose consequent includes the designated hypothetical logical expression, from the inferential knowledge; and
specifying one or more logical expressions included in an antecedent of the extracted inferential knowledge, and extracting one or more observed logical expressions whose predicate is the same as the one or more specified logical expressions, from the observed logical expressions.

9. The inference analysis method according to claim 8, comprising:
presenting the one or more observed logical expressions that are extracted.

10. The inference analysis method according to claim 9, comprising:
classifying the one or more observed logical expressions that are extracted, for the inferential knowledge including the one or more specified logical expressions specified at the time of extracting the one or more observed logical expressions, and presenting, in a classified state, the one or more observed logical expressions that are extracted.

11. The inference analysis method according to claim 9, comprising:
presenting a logical expression not extracted as the one or more observed logical expressions, among the one or more specified logical expressions, in a manner distinguishable from the one or more observed logical expressions that are extracted.

12. The inference analysis method according to claim 9, comprising:
in a case where a plurality of logical expressions are specified and a plurality of observed logical expressions are extracted, determining whether there is a relation between any of the observed logical expressions that are extracted, and collectively presenting extracted observed logical expressions determined to have a relation with each other.

13. The inference analysis method according to claim 8, comprising:
extracting an observed logical expression whose predicate is the same with respect to only a logical expression that satisfies a set condition, among the one or more specified logical expressions.

14. A non-transitory computer-readable recording medium that includes a program recorded thereon, the program including instructions that cause a computer to carry out:
in a case where any of hypothetical logical expressions constituting a hypothesis generated by inference that applies inferential knowledge to observed logical expressions is designated, receiving the designated hypothetical logical expression;
extracting inferential knowledge whose consequent includes the designated hypothetical logical expression, from the inferential knowledge; and
specifying one or more logical expressions included in an antecedent of the extracted inferential knowledge, and extracting one or more observed logical expressions whose predicate is the same as the one or more specified logical expressions, from the observed logical expressions.

15. The non-transitory computer-readable recording medium according to claim 14, the program further including instructions that cause the computer to carry out:
presenting the one or more observed logical expressions that are extracted.

16. The non-transitory computer-readable recording medium according to claim 15,
wherein the program causes the computer to carry out:
classifying the one or more observed logical expressions that are extracted, for the inferential knowledge including the one or more specified logical expressions specified at the time of extracting the one or more observed logical expressions, and presenting, in a classified state, the one or more observed logical expressions that are extracted.

17. The non-transitory computer-readable recording medium according to claim 15,
wherein the program causes the computer to carry out:
presenting a logical expression not extracted as the one or more observed logical expressions, among the one or more specified logical expressions, in a manner distinguishable from the one or more observed logical expressions that are extracted.

18. The non-transitory computer-readable recording medium according to claim 15,
wherein the program causes the computer to carry out:
in a case where a plurality of logical expressions are specified and a plurality of observed logical expressions are extracted, determining whether there is a relation between any of the observed logical expressions that are extracted, and collectively presenting extracted observed logical expressions determined to have a relation with each other.

19. The non-transitory computer-readable recording medium according to claim 14,
wherein the program causes the computer to carry out:
extracting an observed logical expression whose predicate is the same with respect to only a logical expression that satisfies a set condition, among the one or more specified logical expressions.
